(19) United States
(12) Patent Application Publication
(10) Pub. No.: US 2022/0337067 A1
(43) Pub. Date: Oct. 20, 2022

(54) POWER CONTROL APPARATUS AND POWER CONTROL METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Atsushi MATSUZAKI, Sagamihara Kanagawa (JP); Keiko SHIMIZU, Kawasaki Kanagawa (JP); Haruo OGUCHI, Yokohama Kanagawa (JP); Akinori TANI, Kokubunji Tokyo (JP); Takahisa HOSHINO, Yokohama Kanagawa (JP); Kojiro TADA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/562,373

(22) Filed: Dec. 27, 2021

Related U.S. Application Data
(63) Continuation of application No. PCT/JP2021/015752, filed on Apr. 16, 2021.

(51) Int. Cl. H02J 3/46; H02J 3/32

(52) U.S. Cl. CPC H02J 3/46; H02J 3/32

(57) ABSTRACT

A power control apparatus of an embodiment controls power to be output to a power system from a power station including a power generation unit, and a power storage unit. The power control apparatus includes a power generation control unit, a power storage control unit, and a cooperation control unit. The power generation control unit controls an output of the power generation unit based on a power generation set value. The power storage control unit controls an output of the power storage unit based on a power storage set value. The cooperation control unit outputs the power generation set value to the power generation control unit and outputs the power storage set value to the power storage control unit based on a power demand amount of the power system so as to make the power generation unit and the power storage unit operate in a cooperative manner.

### CROSS REFERENCE TO RELATED APPLICATIONS

The present application is a continuation application of International Application No. PCT/JP2021/015752, filed Apr. 16, 2021. The contents of this application are incorporated herein by reference in their entirety.

### FIELD

Embodiments of the present invention relate to a power control apparatus and a power control method.

### BACKGROUND

There is proposed a power control apparatus which controls power of a power station including a power generation unit and a power storage unit. Here, it is proposed to control an output of the power storage unit so that power output from the power generation unit and the power storage unit follows a power demand amount of a power system (refer to Patent Document 1, for example).

However, in the above-described technique, only the power storage unit is controlled, and thus it is sometimes difficult to perform efficient power supply.

Accordingly, the problem to be solved by the present invention is to provide a power control apparatus and a power control method capable of easily realizing efficient power supply.

### BRIEF DESCRIPTION OF THE DRAWINGS

FIG. 1 is a view schematically illustrating a substantial part of a power station according to a first embodiment.

FIG. 2 is a view schematically illustrating a substantial part of a power control apparatus 50 in the power station according to the first embodiment.

FIG. 3 is a view schematically illustrating a substantial part of a cooperation control unit 500 in the power control apparatus 50 according to the first embodiment.

FIG. 4 is a view schematically illustrating a substantial part of a total set value calculator 530 in the cooperation control unit 500 according to the first embodiment.

FIG. 5 is a view schematically illustrating a substantial part of a power generation set value calculator 531 in the cooperation control unit 500 according to the first embodiment.

FIG. 6 is a view schematically illustrating a substantial part of a power storage set value calculator 532 in the cooperation control unit 500 according to the first embodiment.

FIG. 7A is a view illustrating, as an example, a total set value St, a power generation set value Sc, and a power storage set value Sb calculated in the cooperation control unit 500 according to the first embodiment.

FIG. 7B is a view illustrating, as an example, a charged power amount Cb in the first embodiment.

FIG. 8 is a view schematically illustrating a substantial part of a cooperation control unit 500 in a power control apparatus according to a second embodiment.

FIG. 9A is a view illustrating, as an example, a total set value St, a power generation set value Sc, and a power storage set value Sb calculated in the cooperation control unit 500 according to the second embodiment.

FIG. 9B is a view illustrating, as an example, a charged power amount Cb charged in the second embodiment.

FIG. 10 is a view schematically illustrating a substantial part of a cooperation control unit 500 in a power control apparatus according to a third embodiment.

FIG. 11A is a view illustrating, as an example, a total set value St, a power generation set value Sc, and a power storage set value Sb calculated in the cooperation control unit 500 according to the third embodiment.

FIG. 11B is a view illustrating, as an example, a charged power amount Cb charged in the third embodiment.

FIG. 12 is a view schematically illustrating a substantial part of a cooperation control unit 500 in a power control apparatus according to a fourth embodiment.

FIG. 13A is a flowchart illustrating a flow when determining output data in the cooperation control unit 500 according to the fourth embodiment.

FIG. 13B is a flowchart illustrating a flow when determining output data in the cooperation control unit 500 according to the fourth embodiment.

FIG. 13C is a flowchart illustrating a flow when determining output data in the cooperation control unit 500 according to the fourth embodiment.

FIG. 14A is a view illustrating, as an example, a total set value St, a power generation set value Sc, and a power storage set value Sb calculated in the cooperation control unit 500 according to the fourth embodiment.

FIG. 14B is a view illustrating, as an example, a charged power amount Cb charged in the fourth embodiment.

FIG. 15 is a view schematically illustrating a substantial part of a cooperation control unit 500 in a power control apparatus according to a fifth embodiment.

FIG. 16 is a view schematically illustrating a substantial part of a total set value calculator 530 in the cooperation control unit 500 according to the fifth embodiment.

FIG. 17 is a view schematically illustrating a function of a function unit 602 in the total set value calculator 530 according to the fifth embodiment.

FIG. 18 is a view schematically illustrating a substantial part of a demand corrector 601 in the total set value calculator 530 according to the fifth embodiment.

FIG. 19 is a view schematically illustrating a substantial part of a power generation set value calculator 531 in the cooperation control unit 500 according to the fifth embodiment.

FIG. 20A is a view illustrating, as an example, a function of the function unit 602 according to the fifth embodiment.

FIG. 20B is a view illustrating, as an example, a total set value St, a power generation set value Sc, and a power storage set value Sb calculated in the cooperation control unit 500 according to the fifth embodiment.

FIG. 20C is a view illustrating, as an example, a charged power amount Cb in the fifth embodiment.

FIG. 21 is a view illustrating a power generation set value Sc in a sixth embodiment.

### DETAILED DESCRIPTION

A power control apparatus of an embodiment controls power to be output to a power system from a power station including a power generation unit configured to generate power, and a power storage unit configured to charge or discharge power. The power control apparatus includes a power generation control unit, a power storage control unit, and a cooperation control unit. The power generation control unit controls an output of the power generation unit based on a power generation set value. The power storage control unit controls an output of the power storage unit based on a power storage set value. The cooperation control unit outputs the power generation set value to the power generation control unit and outputs the power storage set value to the power storage control unit based on a power demand amount of the power system so as to make the power generation unit and the power storage unit operate in a cooperative manner.

### First Embodiment

[A] Entire Configuration

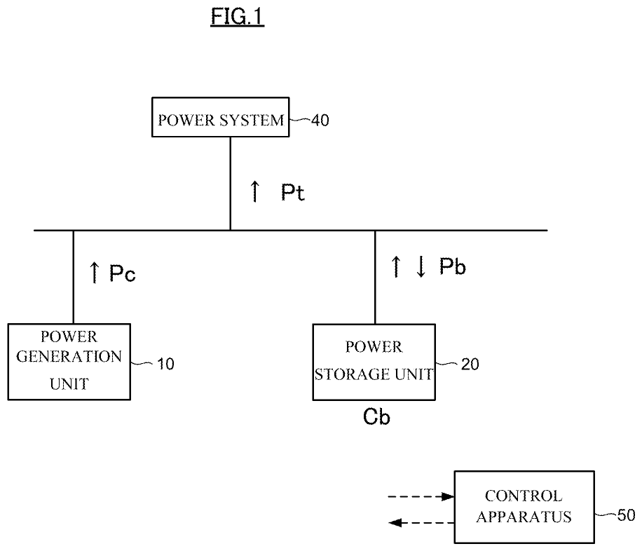

A substantial part of a power station according to a first embodiment will be described by using FIG. 1.

As illustrated in FIG. 1, the power station includes a power generation unit 10, a power storage unit 20, and a power control apparatus 50.

The power generation unit 10 includes, for example, a turbine (illustration thereof is omitted), and a power generator (illustration thereof is omitted) which generates power with the use of the turbine, and is configured to perform power generation.

The power storage unit 20 includes, for example, a storage battery (illustration thereof is omitted), and is configured to perform charge or discharge.

The power control apparatus 50 includes an arithmetic unit (illustration thereof is omitted) and a memory device (illustration thereof is omitted), and is configured to perform control of respective parts when the arithmetic unit performs arithmetic processing by using a program stored in the memory device. Here, to the power control apparatus 50, an operation command, detection data, and so on are input as input signals. Further, the power control apparatus 50 performs the arithmetic processing based on the input signals, and outputs control signals as output signals to the respective parts, to thereby control operations of the respective parts.

Although details will be described later, the power control apparatus 50 is provided for controlling power Pt to be supplied from the power station to a power system 40. The power control apparatus 50 is configured to control a supply operation of the power Pt to the power system 40 by controlling a power generation operation in which the power generation unit 10 outputs power Pc, and a discharge operation in which the power storage unit 20 outputs power Pb. Further, the power control apparatus 50 is configured to control a charge operation in which the power storage unit 20 stores the power Pb.

[B] Power Control Apparatus 50

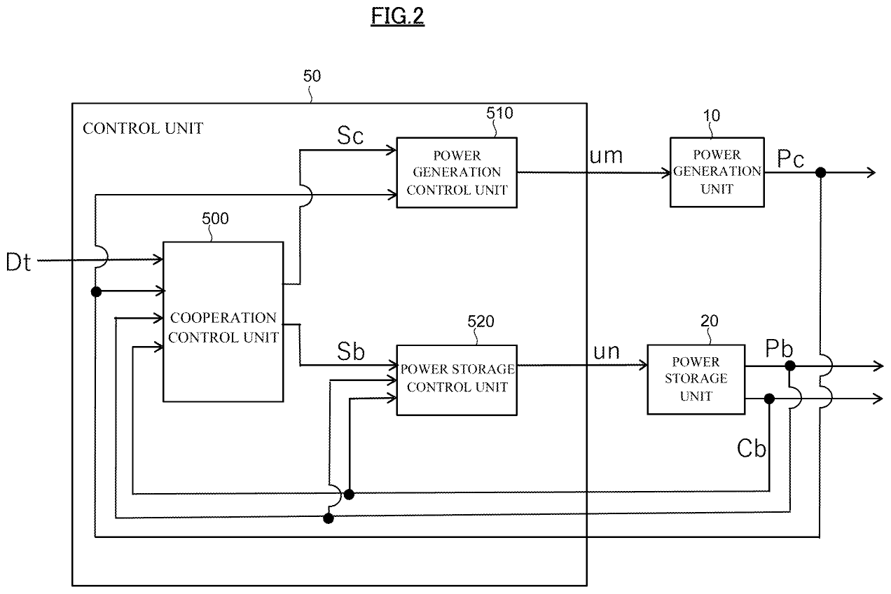

A substantial part of the power control apparatus 50 will be described by using FIG. 2.

As illustrated in FIG. 2, the power control apparatus 50 includes a cooperation control unit 500, a power generation control unit 510, and a power storage control unit 520.

The cooperation control unit 500 is configured to output a power generation set value Sc to the power generation control unit 510, and output a power storage set value Sb to the power storage control unit 520, based on a power demand amount Dt of the power system 40, so as to make the power generation unit 10 and the power storage unit 20 operate in a cooperative manner.

The power generation control unit 510 is configured such that the power generation set value Sc output by the cooperation control unit 500 is input thereto, and it controls the power generation unit 10 based on the power generation set value Sc.

The power storage control unit 520 is configured such that the power storage set value Sb output by the cooperation control unit 500 is input thereto, and it controls the power storage unit 20 based on the power storage set value Sb.

Here, a power amount Pc output by the power generation unit 10 is input, as an input signal, to each of the cooperation control unit 500 and the power generation control unit 510. Further, a power amount Pb output by the power storage unit 20, and a charged power amount Cb charged in the power storage unit 20 are input, as input signals, to each of the cooperation control unit 500 and the power storage control unit 520.

The cooperation control unit 500 outputs the power generation set value Sc and outputs the power storage set value Sb, in accordance with the power amount Pc output by the power generation unit 10, the power amount Pb output by the power storage unit 20, and the charged power amount Cb charged in the power storage unit 20.

Further, the power generation control unit 510 controls the power generation unit 10 in accordance with the power amount Pc output by the power generation unit 10. For example, when the power amount Pc output by the power generation unit 10 is different from a power amount according to the power generation set value Sc, the power generation control unit 510 controls the power generation unit 10 so that the power amount Pc becomes the power amount in accordance with the power generation set value Sc.

Further, the power storage control unit 520 controls the power storage unit 20 in accordance with the power amount Pb output by the power storage unit 20, and the charged power amount Cb charged in the power storage unit 20. For example, when the power amount Pb output by the power storage unit 20 is different from a power amount according to the power storage set value Sb, the power storage control unit 520 controls the power storage unit 20 so that the power amount Pb becomes the power amount in accordance with the power storage set value Sb.

[C] Cooperation Control Unit 500

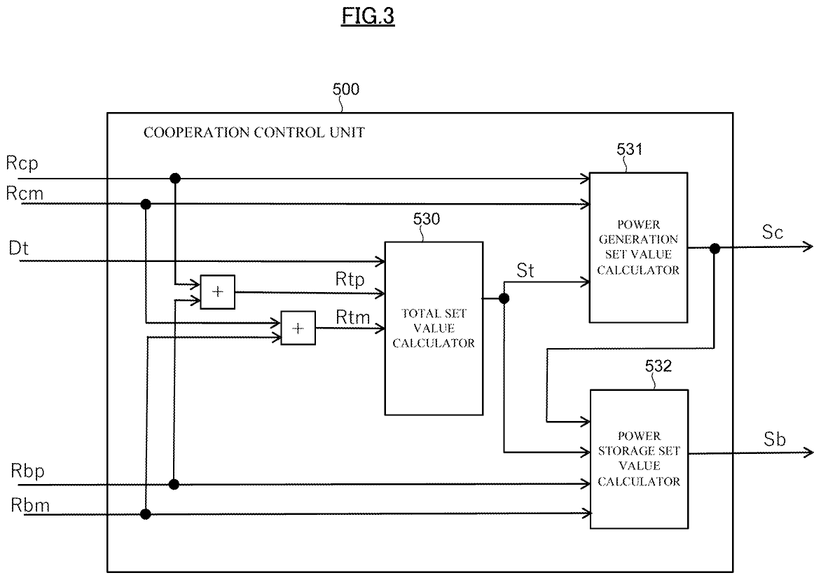

A substantial part of the cooperation control unit 500 will be described by using FIG. 3.

As illustrated in FIG. 3, the cooperation control unit 500 includes a total set value calculator 530, a power generation set value calculator 531, and a power storage set value calculator 532.

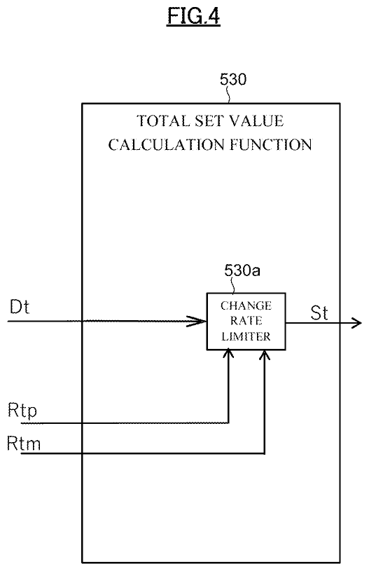

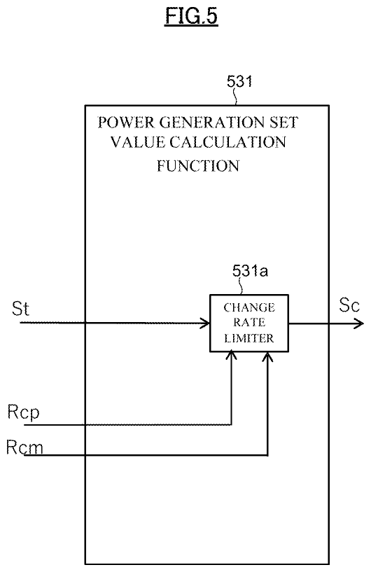

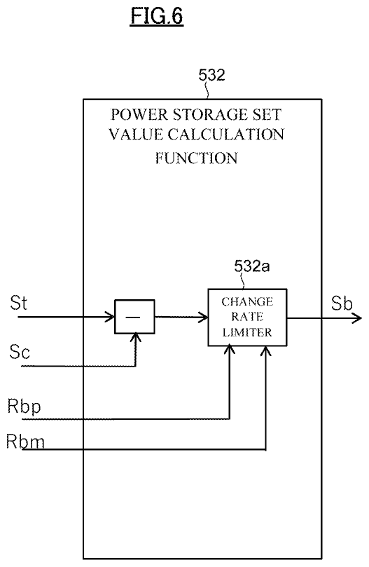

FIG. 4 is a view schematically illustrating a substantial part of the total set value calculator 530 in the cooperation control unit 500 according to the first embodiment. FIG. 5 is a view schematically illustrating a substantial part of the power generation set value calculator 531 in the cooperation control unit 500 according to the first embodiment. FIG. 6 is a view schematically illustrating a substantial part of the power storage set value calculator 532 in the cooperation control unit 500 according to the first embodiment.

[C-1] Total Set Value Calculator 530

The total set value calculator 530 will be described by using FIG. 3 and FIG. 4.

As illustrated in FIG. 3, the power demand amount Dt of the power system 40 is input, as an input signal, to the total set value calculator 530. Further, an added value Rtp obtained by adding an increase-side output change rate Rcp of the power generation unit 10 and an increase-side output change rate Rbp of the power storage unit 20, is input, as an input signal, to the total set value calculator 530. Other than the above, an added value Rtm obtained by adding a decrease-side output change rate Rcm of the power generation unit 10 and a decrease-side output change rate Rbm of the power storage unit 20, is input, as an input signal, to the total set value calculator 530. The increase-side output change rate Rcp and the decrease-side output change rate Rcm are set on the outside in accordance with a state of the power generation unit 10, for example, and then input in a manner as described above. Further, the increase-side output change rate Rbp and the decrease-side output change rate Rbm are set on the outside in accordance with a state of the power storage unit 20, for example, and then input in a manner as described above.

As illustrated in FIG. 4, the total set value calculator 530 includes a change rate limiter 530a, and each of the power demand amount Dt, the added value Rtp, and the added value Rtm is input to the change rate limiter 530a. The change rate limiter 530a calculates, based on the input signals, a total set value St being a set value of power as a result of totalizing power to be output by the power generation unit 10 and power to be output by the power storage unit 20.

[C-2] Power Generation Set Value Calculator 531

The power generation set value calculator 531 will be described by using FIG. 3 and FIG. 5.

As illustrated in FIG. 3, the total set value St is input, as an input signal, to the power generation set value calculator 531. Besides, the increase-side output change rate Rcp and the decrease-side output change rate Rcm are input, as input signals, to the power generation set value calculator 531.

As illustrated in FIG. 5, the power generation set value calculator 531 includes a change rate limiter 531a, and each of the total set value St, the increase-side output change rate Rcp, and the decrease-side output change rate Rcm is input to the change rate limiter 531a. Based on the input signals, the change rate limiter 531a calculates and outputs a power generation set value Sc being a set value of power to be output by the power generation unit 10.

[C-3] Power Storage Set Value Calculator 532

The power storage set value calculator 532 will be described by using FIG. 3 and FIG. 6.

As illustrated in FIG. 3, the total set value St, and the power generation set value Sc are input, as input signals, to the power storage set value calculator 532. Besides, the increase-side output change rate Rbp and the decrease-side output change rate Rbm are input, as input signals, to the power storage set value calculator 532.

As illustrated in FIG. 6, the power storage set value calculator 532 includes a change rate limiter 532a, and an added value of the total set value St and the power generation set value Sc, the increase-side output change rate Rbp, and the decrease-side output change rate Rbm, are input to the change rate limiter 532a. Subsequently, based on the above-described input signals, the change rate limiter 532a calculates and outputs a power storage set value Sb being a set value of power to be output by the power storage unit 20.

[D] Regarding Total Set Value St, Power Generation Set Value Sc, Power Storage Set Value Sb, and Charged Power Amount Cb

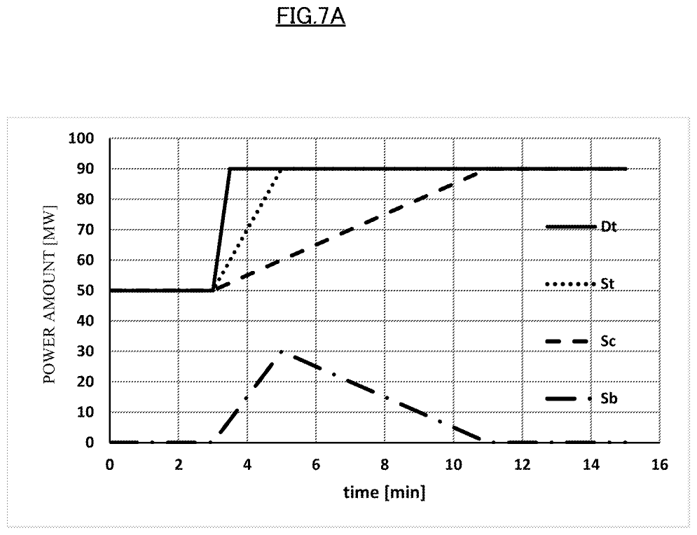

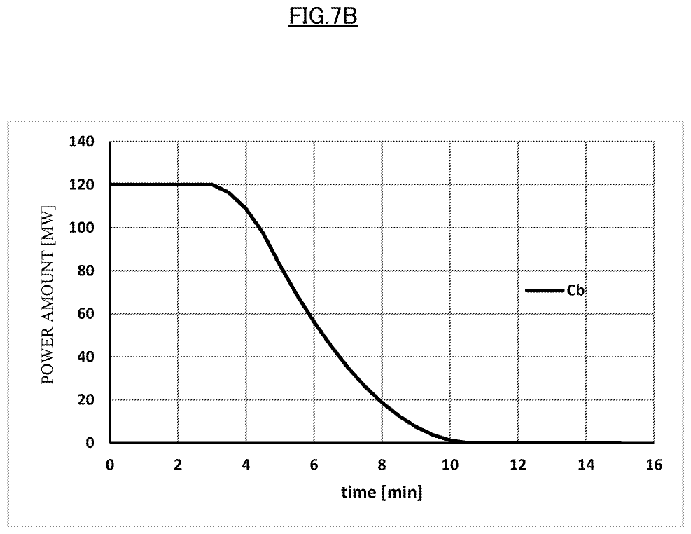

The total set value St, the power generation set value Sc, and the power storage set value Sb calculated in the cooperation control unit 500 will be described by using FIG. 7A. Further, the charged power amount Cb charged in the power storage unit 20 when calculating the total set value St, the power generation set value Sc, and the power storage set value Sb as described above, will be described by using FIG. 7B.

Each of FIG. 7A and FIG. 7B illustrates, as an example, a state in which rising of the power demand amount Dt at a 3-minute time point is unknown at a 0-minute time point, and the rising of the power demand amount Dt is confirmed at the 3-minute time point (present time point).

As illustrated in FIG. 7A, the total set value St rises at a rate lower than a rate at which the power demand amount Dt of the power system 40 rises. For example, the power demand amount Dt rises from 50 MW to 90 MW during a period from the 3-minute time point to a 3.5-minute time point, but the total set value St is set to rise from 50 MW to 90 MW during a period from the 3-minute time point to a 5-minute time point. Further, the total set value St keeps a fixed value at the 5-minute time point and thereafter, similarly to the power demand amount Dt of the power system 40.

As illustrated in FIG. 7A, the power generation set value Sc is set to rise at a rate lower than the rate at which the total set value St rises, by taking characteristics of the power generation unit 10 into consideration. For example, the power generation set value Sc is set to make a power amount rise from 50 MW to 90 MW during a period from the 3-minute time point to an 11-minute time point. Further, the power generation set value Sc keeps a fixed value at the 11-minute time point and thereafter, for example, similarly to the power demand amount Dt of the power system 40.

As illustrated in FIG. 7A, the power storage set value Sb is set so that a value as a result of totalizing the power generation set value Sc and the power storage set value Sb becomes the same as the total set value St at each time point. For example, during a period from the 3-minute time point to the 5-minute time point, the power generation set value Sc rises at the rate lower than the rate at which the total set value St rises, as described above, so that based only on the power generation set value Sc, the power amount is in a state of being lower than that according to the total set value St. Therefore, the power storage set value Sb is made to rise so that the value as a result of totalizing the power generation set value Sc and the power storage set value Sb coincides with the total set value St. When, at the 5-minute time point and thereafter, the power storage set value Sb is made to rise at a rate similar to that from the 3-minute time point to the 5-minute time point, the value as a result of totalizing the power generation set value Sc and the power storage set value Sb exceeds the total set value St. For this reason, at the 5-minute time point and thereafter, the power storage set value Sb is made to decrease in accordance with passage of time.

At this time, the charged power amount Cb charged in the power storage unit 20 decreases in accordance with the passage of time at the 3-minute time point and thereafter, as illustrated in FIG. 7B. Here, the charged power amount Cb shifts from a state of 120 MW at the 3-minute time point to a state of 0 MW at the 11-minute time point, for instance.

Note that in the present embodiment, a rate of a part at which the power amount is increased, of the total set value St, corresponds to the added value Rtp obtained by adding the increase-side output change rate Rcp of the power generation unit 10 and the increase-side output change rate Rbp of the power storage unit 20. A rate of a part at which the power amount is increased, of the power generation set value Sc, corresponds to the increase-side output change rate Rcp of the power generation unit 10. A rate of a part at which the power amount is increased, of the power storage set value Sb, corresponds to the increase-side output change rate Rbp of the power storage unit 20.

[E] Summary

As described above, in the power control apparatus 50 of the present embodiment, the cooperation control unit 500 outputs the power generation set value Sc to the power generation control unit 510 and outputs the power storage set value Sb to the power storage control unit 520, based on the power demand amount Dt of the power system 40, so as to make the power generation unit 10 and the power storage unit 20 operate in a cooperative manner. As described above, in the present embodiment, the power generation set value Sc is output to the power generation control unit 510, to thereby control the power generation unit 10, and the power storage set value Sb is output to the power storage control unit 520, to thereby control the power storage unit 20. Specifically, in the present embodiment, in order to supply power in accordance with the power demand amount Dt of the power system 40, not only the power storage unit 20 but also the power generation unit 10 is controlled. Therefore, in the present embodiment, it is possible to easily realize efficient power supply.

Further, the cooperation control unit 500 of the present embodiment outputs the power generation set value Sc and the aforementioned power storage set value Sb, based on the increase-side output change rate Rcp, the decrease-side output change rate Rcm, the increase-side output change rate Rbp, and the decrease-side output change rate Rbm. Accordingly, in the present embodiment, the control of the power generation unit 10 and the control of the power storage unit 20 are performed in accordance with the characteristics of the power generation unit 10 and the power storage unit 20, and thus it is possible to easily realize efficient power supply.

### Second Embodiment

[A] Cooperation Control Unit 500

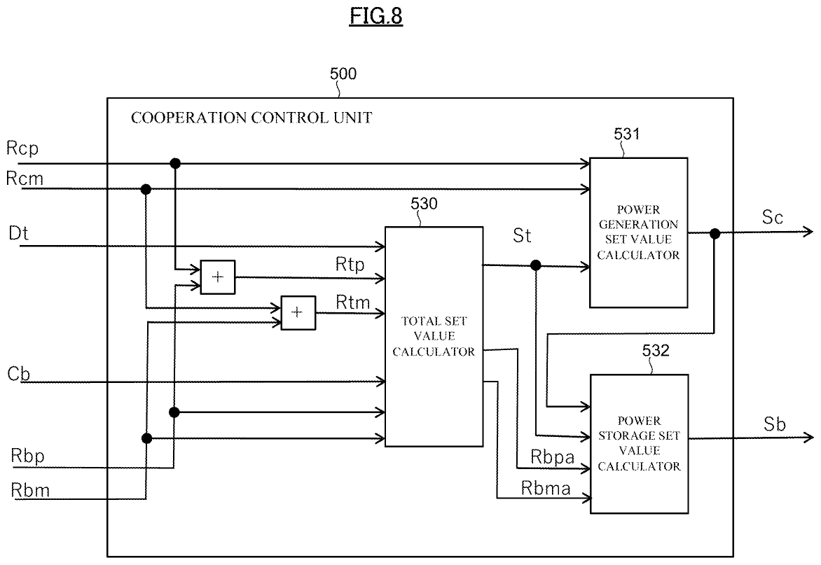

A substantial part of a cooperation control unit 500 of the present embodiment will be described by using FIG. 8.

Unlike the first embodiment (refer to FIG. 3), data of the charged power amount Cb charged in the power storage unit 20 is input to the cooperation control unit 500 of the present embodiment, as illustrated in FIG. 8. Except for this point and points related thereto, the present embodiment is similar to the above-described embodiment. For this reason, explanation of overlapped parts will be appropriately omitted.

Concretely, in the cooperation control unit 500, the data of the charged power amount Cb is further input, as an input signal, to the total set value calculator 530. The total set value calculator 530 calculates the total set value St based on not only the power demand amount Dt, the added value Rtp, and the added value Rtm, but also the charged power amount Cb. In addition to this, the total set value calculator 530 corrects, based on the respective pieces of data input as described above, the increase-side output change rate Rbp and the decrease-side output change rate Rbm, and outputs a corrected increase-side output change rate Rbpa and a corrected decrease-side output change rate Rbma to the power storage set value calculator 532. Here, for example, in accordance with the change in the value of the charged power amount Cb, the value of the power demand amount Dt, and the value of the total set value St, the increase-side output change rate Rbp and the decrease-side output change rate Rbm are output as the corrected increase-side output change rate Rbma and the corrected decrease-side output change rate Rbma.

Subsequently, the power storage set value calculator 532 calculates the power storage set value Sb based on not only the total set value St and the power generation set value Sc, but also the corrected increase-side output change rate Rbpa and the corrected decrease-side output change rate Rbma.

[B] Regarding Total Set Value St, Power Generation Set Value Sc, Power Storage Set Value Sb, and Charged Power Amount Cb

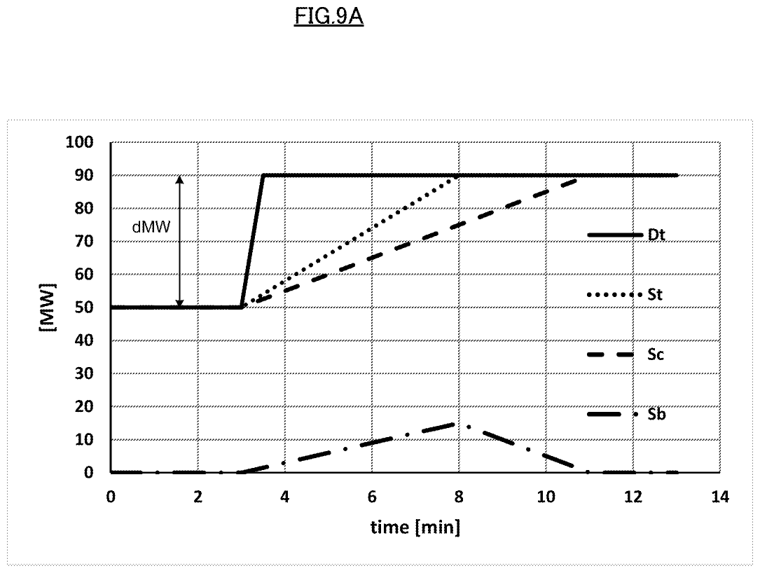

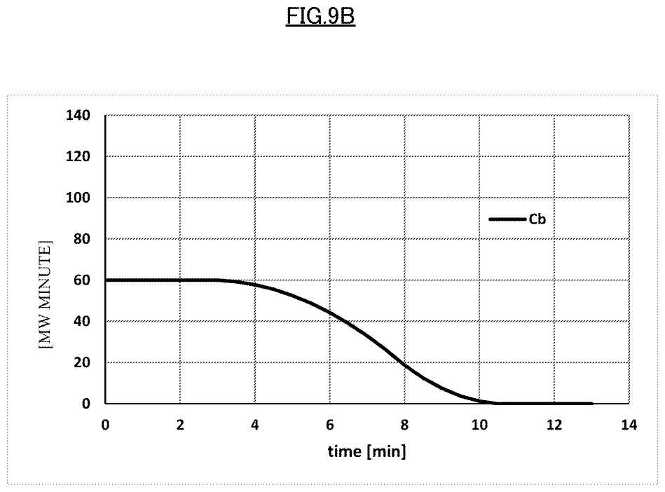

The total set value St, the power generation set value Sc, and the power storage set value Sb calculated in the cooperation control unit 500, will be described by using FIG. 9A. Further, the charged power amount Cb charged in the power storage unit 20 when calculating the total set value St, the power generation set value Sc, and the power storage set value Sb as described above, will be described by using FIG. 9B.

Each of FIG. 9A and FIG. 9B illustrates, as an example, a state in which rising of the power demand amount Dt at a 3-minute time point is unknown at a 0-minute time point, and the rising of the power demand amount Dt is confirmed at the 3-minute time point (present time point), similarly to the case of FIG. 7A and FIG. 7B.

In the present embodiment, as illustrated in FIG. 9B, the charged power amount Cb is smaller than that of the first embodiment (FIG. 7B). Here, the initial charged power amount Cb in the first embodiment is 120 MW, but the initial charged power amount Cb in the present embodiment is 60 MW. As described above, since the initial charged power amount Cb of the present embodiment is smaller than that of the first embodiment, the total set value St and the power storage set value Sb are set to a state different from that of the first embodiment, in accordance with the small charged power amount Cb, as illustrated in FIG. 9A.

Concretely, the total set value St is set to rise at a rate lower than that of the first embodiment, as illustrated in FIG. 9A. For example, the total set value St is set to rise from 50 MW to 90 MW during a period from the 3-minute time point to the 5-minute time point in the first embodiment, but in the present embodiment, the total set value St is set to rise from 50 MW to 90 MW during a period from the 3-minute time point to an 8-minute time point. Further, the total set value St keeps a fixed value at the 8-minute time point and thereafter, for example, similarly to the power demand amount Dt of the power system 40.

As illustrated in FIG. 9A, the power generation set value Sc is set to make a power amount rise from 50 MW to 90 MW during a period from the 3-minute time point to an 11-minute time point, for example, similarly to the first embodiment. Further, the power generation set value Sc keeps a fixed value at the 11-minute time point and thereafter, for example, similarly to the power demand amount Dt of the power system 40.

As illustrated in FIG. 9A, the power storage set value Sb is set so that a value as a result of totalizing the power generation set value Sc and the power storage set value Sb becomes the same as the total set value St at each time. For example, during a period from the 3-minute time point to the 8-minute time point, the power generation set value Sc rises at a rate lower than the rate at which the total set value St rises, so that based only on the power generation set value Sc, the power amount is in a state of being lower than that according to the total set value St. Therefore, the power storage set value Sb is made to rise so that the value as a result of totalizing the power generation set value Sc and the power storage set value Sb coincides with the total set value St. When, at the 8-minute time point and thereafter, the power storage set value Sb is made to rise at a rate similar to that from the 3-minute time point to the 8-minute time point, the value as a result of totalizing the power generation set value Sc and the power storage set value Sb exceeds the total set value St. For this reason, at the 8-minute time point and thereafter, the power storage set value Sb is made to decrease in accordance with passage of time.

At this time, the charged power amount Cb charged in the power storage unit 20 decreases in accordance with the passage of time, as illustrated in FIG. 9B. The charged power amount Cb shifts from a state of 60 MW at the 3-minute time point to a state of 0 MW at the 11-minute time point, for instance.

Note that a rate Rtpa of a part at which the power amount is increased, of the total set value St, can be determined as in a following mathematical equation (A). In the following equation (A), dMW indicates a change amount of the power demand amount Dt, as can be understood with reference to FIG. 9A.

Rtpa=dMW/(dMW/Rcp−2*Cb/dMW) (A)

Further, a rate of a part at which the power amount is increased, of the power generation set value Sc, corresponds to the corrected increase-side output change rate Rcpa. A rate of a part at which the power amount is increased, of the power storage set value Sb, corresponds to the corrected increase-side output change rate Rbpa.

[C] Summary

As described above, in the power control apparatus 50 of the present embodiment, the cooperation control unit 500 determines the total set value St based on the charged power amount Cb charged in the power storage unit 20, and outputs the power generation set value Sc and the power storage set value Sb in accordance with the total set value St. Therefore, in the present embodiment, it is possible to easily realize efficient power supply.

Concretely, if, in the case where the charged power amount Cb is small as in the present embodiment, the power storage unit 20 performs the output based on the increase-side output change rate Rbp and the decrease-side output change rate Rbm similar to those of the first embodiment described above, the charged power amount Cb may become zero before the total set value St reaches the power demand amount Dt. However, in the present embodiment, the increase-side output change rate Rbp and the decrease-side output change rate Rbm are corrected so as to prevent the charged power amount Cb from becoming zero before the total set value St reaches the power demand amount Dt. For this reason, in the present embodiment, it is possible to accurately deal with the requested power demand amount Dt.

### Third Embodiment

[A] Cooperation Control Unit 500

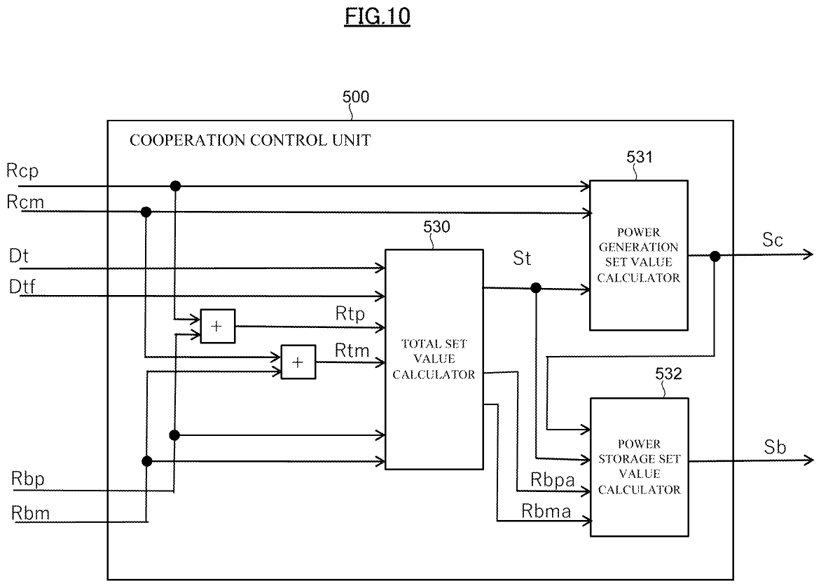

A substantial part of a cooperation control unit 500 of the present embodiment will be described by using FIG. 10.

Unlike the second embodiment (refer to FIG. 8), not only the power demand amount Dt at the present time point but also data of a power demand amount Dtf in the future is input to the cooperation control unit 500 of the present embodiment, as illustrated in FIG. 10. Except for this point and points related thereto, the present embodiment is similar to the above-described embodiments. For this reason, explanation of overlapped parts will be appropriately omitted.

Concretely, in the cooperation control unit 500, the data of the power demand amount Dtf in the future is further input, as an input signal, to the total set value calculator 530. The power demand amount Dtf in the future is input as a digit sequence such as a power demand amount Dt(1) at a first time point, a power demand amount Dt(2) at a second time point, . . . , and a power demand amount Dt(n) at an n-th time point. Subsequently, the total set value calculator 530 uses the input data such as the power demand amount Dtf in the future, to calculate the total set value St.

Subsequently, the power generation set value calculator 531 calculates and outputs the power generation set value Sc, based on the total set value St calculated as described above, and so on. Further, the power storage set value calculator 532 calculates and outputs the power storage set value Sb, based on the total set value St calculated as described above, and so on.

[B] Regarding Total Set Value St, Power Generation Set Value Sc, Power Storage Set Value Sb, and Charged Power Amount Cb

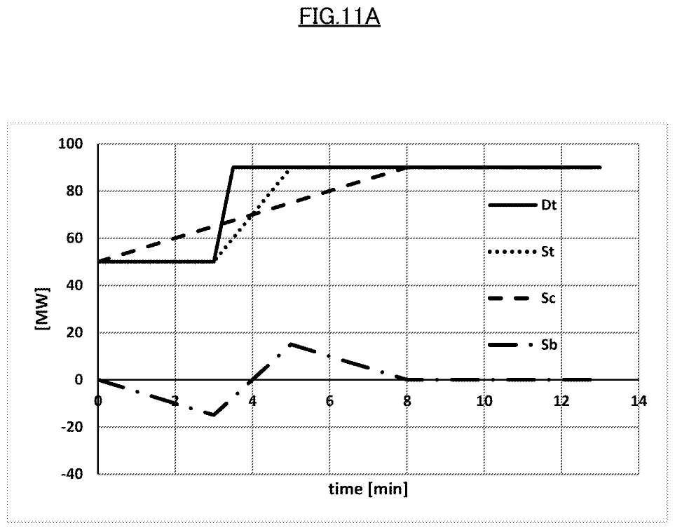

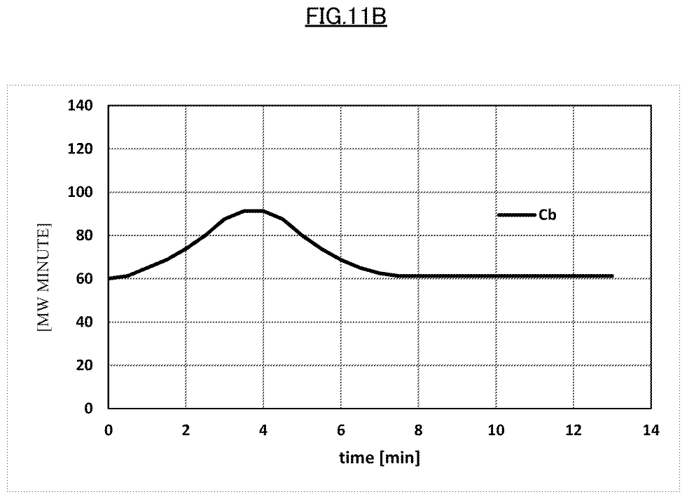

The total set value St, the power generation set value Sc, and the power storage set value Sb calculated in the cooperation control unit 500, will be described by using FIG. 11A. Further, the charged power amount Cb charged in the power storage unit 20 when calculating the total set value St, the power generation set value Sc, and the power storage set value Sb as described above, will be described by using FIG. 11B.

Each of FIG. 11A and FIG. 11B illustrates, as an example, a state in which rising of the power demand amount Dt at a 3-minute time point is already known at a 0-minute time point (present time point), unlike the case illustrated in FIG. 9A and FIG. 9B.

As illustrated in FIG. 11A, the total set value St is set to rise from 50 MW to 90 MW during a period from the 3-minute time point to a 5-minute time point, according to the timing of rising of the power demand amount Dt. Further, the total set value St keeps a fixed value at the 5-minute time point and thereafter, for example, similarly to the power demand amount Dt of the power system 40.

However, in the present embodiment, the rising of the power demand amount Dt at the 3-minute time point is already known at the 0-minute time point (present time point), as described above. For this reason, in the present embodiment, the power generation set value Sc is set to rise before the rising of the power demand amount Dt, as illustrated in FIG. 11A. Concretely, the power generation set value Sc is set to make a power amount rise from 50 MW to 90 MW during a period from the 0-minute time point (present time point) to an 8-minute time point by passing through the time point (3-minute time point) at which the power demand amount Dt rises, for example. Further, the power generation set value Sc keeps a fixed value at the 8-minute time point and thereafter, for example, similarly to the power demand amount Dt of the power system 40.

The power generated by the power generation unit 10 so as to correspond to the power generation set value Sc before the rising of the power demand amount Dt, is not required to be output to the power system 40, so that the power is charged in the power storage unit 20. For this reason, the power storage set value Sb indicates that the charge is performed during a period from the 0-minute time point (present time point) to a 4-minute time point, and the discharge is performed at the 4-minute time point and thereafter.

At this time, the charged power amount Cb charged in the power storage unit 20 increases when performing the charge, and it decreases when performing the discharge, as illustrated in FIG. 11B. For instance, the charge is performed from the state where the charged power amount Cb is 60 MW at the 0-minute time point to 90 MW, and the discharge is performed from that state to 60 MW.

Summary

As described above, in the power control apparatus 50 of the present embodiment, the cooperation control unit 500 outputs the power generation set value Sc and the power storage set value Sb based on not only the power demand amount Dt at the present time point but also the power demand amount Dtf in the future. For this reason, in the present embodiment, it is possible to increase the power generation set value Sc before increasing the total set value St due to the request of the power demand amount Dt, as described above. As a result of this, before increasing the total set value St due to the request of the power demand amount Dt, the power generated in the power generation unit 10 can be output to the power storage unit 20, and can be charged in the power storage unit 20. Therefore, in the present embodiment, it is possible to easily realize efficient power supply.

### Fourth Embodiment

[A] Cooperation Control Unit 500

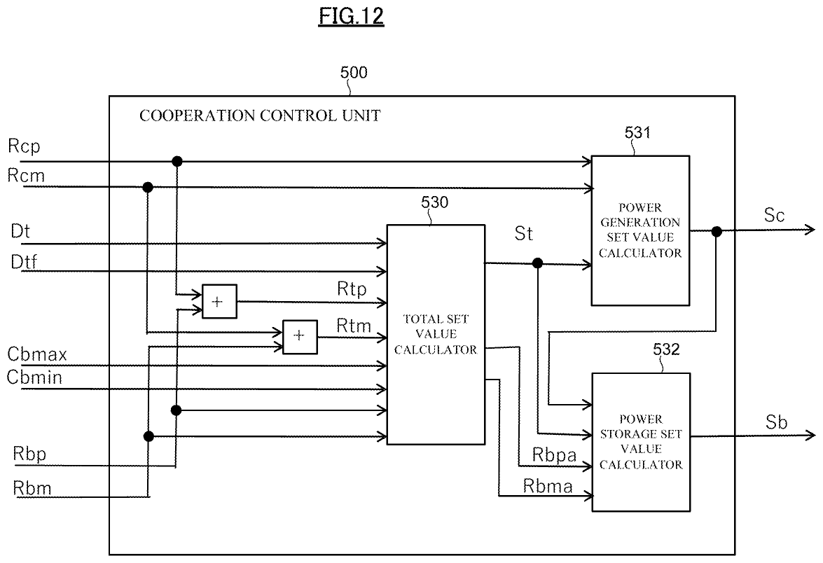

A substantial part of a cooperation control unit 500 of the present embodiment will be described by using FIG. 12.

Unlike the third embodiment (refer to FIG. 10), data of an upper limit value Cbmax [MW] (positive value) of a power amount to be stored in the power storage unit 20 and data of a lower limit value Cbmin [MW] (zero or positive value) of the power amount to be stored in the power storage unit 20 are input to the cooperation control unit 500 of the present embodiment, as illustrated in FIG. 12. Except for this point and points related thereto, the present embodiment is similar to the above-described embodiments. For this reason, explanation of overlapped parts will be appropriately omitted.

Concretely, in the cooperation control unit 500, the data of the upper limit value Cbmax [MW] (positive value) of the power amount to be stored in the power storage unit 20 and the data of the lower limit value Cbmin [MW] (zero or positive value) of the power amount to be stored in the power storage unit 20 are further input, as input signals, to the total set value calculator 530. Subsequently, the total set value calculator 530 uses the respective pieces of input data to calculate the total set value St, and so on.

Subsequently, the power generation set value calculator 531 calculates and outputs the power generation set value Sc, based on the total set value St calculated as described above, and so on. Further, the power storage set value calculator 532 calculates and outputs the power storage set value Sb, based on the total set value St calculated as described above, and so on.

[B] Calculation Method

In the present embodiment, the cooperation control unit 500 can output respective pieces output data by solving a constrained optimization problem as indicated in a following (equation 1), for example. Here, it is possible to decide a total set value St(0) at a next time point, a corrected increase-side output change rate Rbpa, and a corrected decrease-side output change rate Rbma, so that the charged power amount Cb charged in the power storage unit 20 falls within a range between the upper limit value Cbmax and the lower limit value Cbmin.

[Mathematical equation 1]

minimize J=Σₖ₌₁^{N}{Dtf(k)−St(k)}² (Equation 1)

Subject to:

Cb min≤Cb(k)≤Cb max

St(k)=Sc(k)+Sb(k)

Sc(k)−Rcm*dt≤Sc(k+1)≤Sc(k)+Rcp*dt

Sb(k)−Rbm*dt≤Sb(k+1)≤Sb(k)+Rbp*dt

Sb(k+1)≤Cb(k)−Rbp*dt

Cb(k+1)=Cb(k)+(Sb(k+1)−Sb(k))*dt

Sc min≤Sc(k)≤Sc max

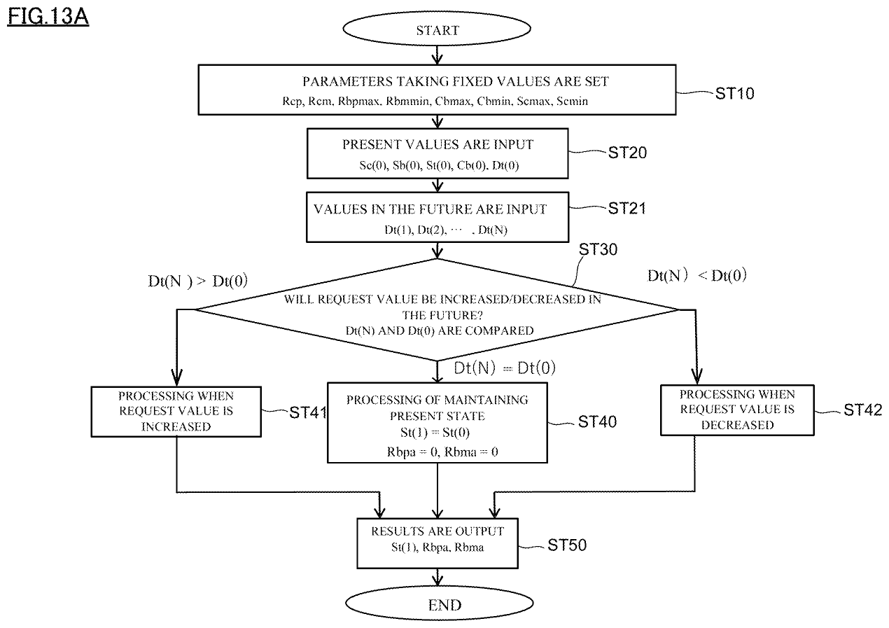

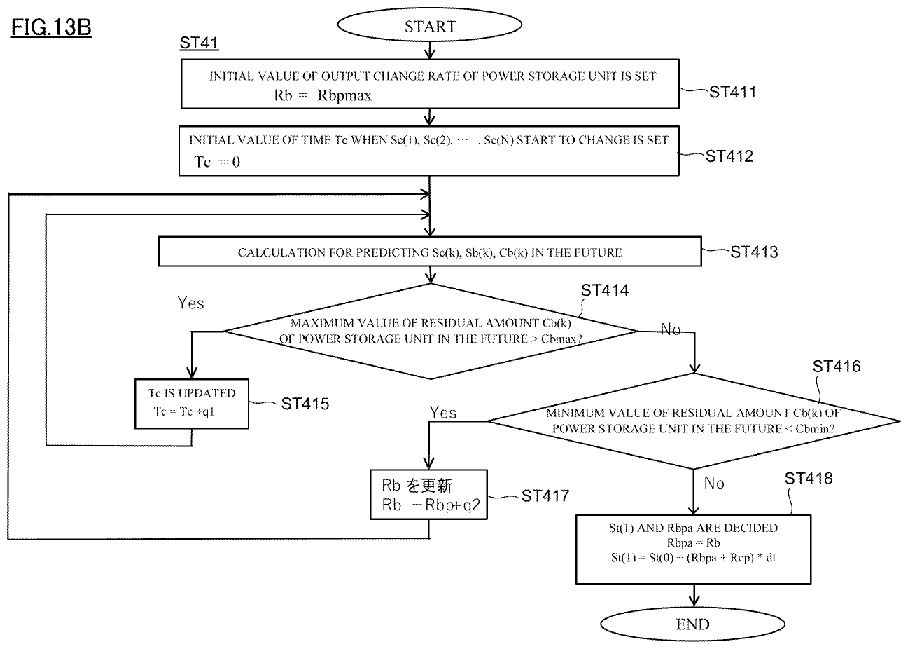

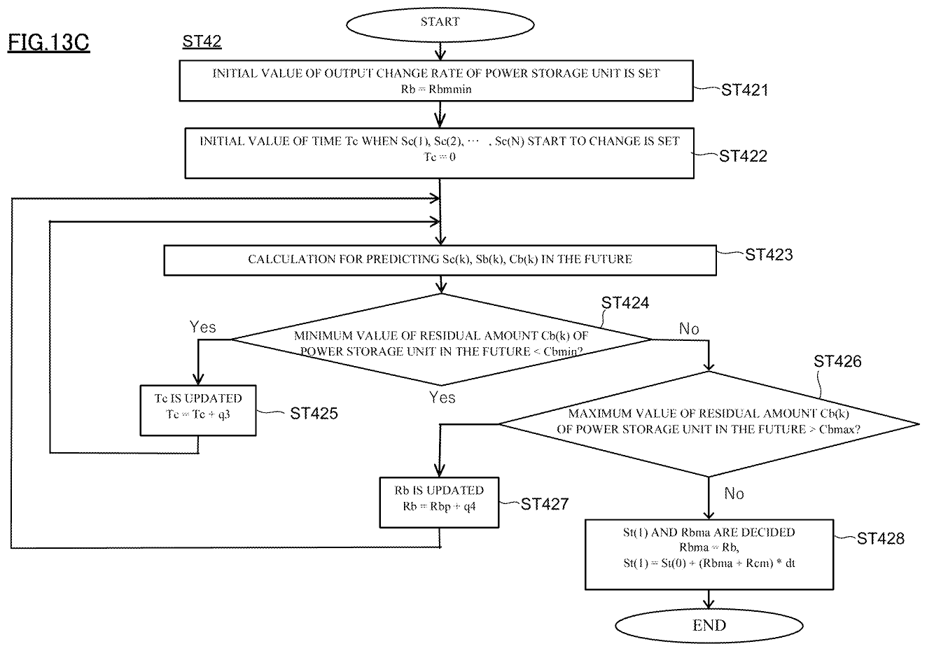

A flow when calculating the optimal solution for determining the output data in the cooperation control unit 500 will be described by using FIG. 13A, FIG. 13B, and FIG. 13C. The flows illustrated in FIG. 13A, FIG. 13B, and FIG. 13C are performed through a simple repeated calculation method. The optimal solution can be calculated by using, instead of the flows illustrated in FIG. 13A, FIG. 13B, and FIG. 13C, generally well-known optimization algorithms such as, for example, a steepest descent method, a Newton-Raphson method, and a conjugate direction method.

Hereinafter, factors used in the above (equation 1) and the flows in FIG. 13A, FIG. 13B, and FIG. 13C will be cited (including already-described factors).

(a) Factors which do not Change Depending on Time (Constants)
Rcp: Increase-side output change rate of power generation unit 10 (0 or positive value, [MW/minute])
Rcm: Decrease-side output change rate of power generation unit 10 (0 or negative value, [MW/minute])
Rbpmax: Maximum value of increase-side output change rate Rbp of power storage unit 20 (positive value, [MW/minute])
Rbmmin: Minimum value of decrease-side output change rate Rbm of power storage unit 20 (negative value, [MW/minute])
Cbmax: Maximum value of charged power amount (residual amount) of power storage unit 20 (positive value, [MW minute])
Cbmin: Minimum value of charged power amount (residual amount) of power storage unit 20 (0 or positive value, [MW minute])
Scmax: Maximum value of output of power generation unit 10 (positive value, [MW])
Scmin: Minimum value of output of power generation unit 10 (positive value, [MW])
dt: Period between time point k and time point k+1 in next step (step width, [minute])

(b) Factors which Change with Passage of Time (Variables) ((k) Means Value at Time Point k, and (0) Means Value at Present Time Point)
Cb(0): Charged power amount (residual amount) of power storage unit 20 (0 or positive value, [MW minute])
Dt(0): power demand amount Dt (total output request value, positive value, [MW])
Sc(k): Output set value of power generation unit 10 (positive value, [MW])
Sb(k): Output set value of power storage unit 20 (positive value means discharge, and negative value means storage (charge), [MW])
St(0): Total output set value of power generation unit 10 and power storage unit 20 (positive value, [MW])

(c) Factors Obtained Through Calculation (Variables)
Rbpa: Increase-side output change rate (corrected) of power storage unit 20 (0 or positive value, [MW/minute])
Rbma: Decrease-side output change rate (corrected) of power storage unit 20 (0 or negative value, [MW/minute])

(d) Intermediate Variables
Rb: Change rate of power storage unit 20 (positive value, 0, or negative value, [MW/minute])
Tc: Time when power generation set value Sc (output set value) of power generation unit 10 is started to change ([minute])

(e) Parameters for Optimization
q1, q2, q3, a4: arbitrary positive values (appropriate values are set at first)

[B-1] Step ST10

When determining output data in the cooperation control unit 500, at first, parameters taking fixed values (Rcp, Rcm, Rbpmax, Rbmmin, Cbmax, Cbmin, Scmax, Scmin) are set, as illustrated in FIG. 13A (ST10).

[B-2] Step ST20

Next, values at the present time point (Sc(0), Sb(0), St(0), Cb(0), Dt(0)) are input (ST20).

[B-3] Step ST21

Next, values at time points in the future (Dt(1), Dt(2), . . . , Dt(N)) are input (ST21).

[B-4] Step ST30

Next, judgment is made regarding whether the power demand amount Dt (total output request value) will be increased/decreased or maintained in the future (ST30). Here, the power demand amount Dt(0) at the present time point and the power demand amount Dt(N) at the time point in the future are compared.

[B-5] Step ST40

When the power demand amount Dt(0) at the present time point and the power demand amount Dt(N) at the time point in the future are the same, processing of maintaining the present state is performed. Here, a total set value St(1) at a time point of one step later is set to the same value as the total set value St(0) at the present time point (St(1)=St(0)). Further, values of the corrected increase-side output change rate Rbpa and the corrected decrease-side output change rate Rbma are set to zero.

[B-6] Step ST41

When the power demand amount Dt(N) at the time point in the future is larger than the power demand amount Dt(0) at the present time point, processing when the request value is increased, is performed (ST41). The processing when the request value is increased will be described later.

[B-7] Step ST42

When the power demand amount Dt(N) at the time point in the future is smaller than the power demand amount Dt(0) at the present time point, processing when the request value is increased, is performed (ST42). The processing when the request value is decreased will be described later.

[B-8] Processing when Request Value is Increased

The aforementioned processing when the request value is increased (refer to ST41 in FIG. 13A) will be described by using FIG. 13B.

[B-8-1] Step ST411 When performing the processing when the request value is increased, as illustrated in FIG. 13B, an initial value of the output change rate Rb of the power storage unit 20 is first set in step ST411. Here, the output change rate Rb of the power storage unit 20 is set to the maximum value Rbpmax (Rb=Rbpmax).

[B-8-2] Step ST412

Next, in step ST412, an initial value of the time point Tc when the power generation set values Sc(1), Sc(2), . . . , Sc(N) at respective time points start to change is set. Here, the present time point (0) is set as the time point Tc (Tc=0).

[B-8-3] Step ST413

Next, in step ST413, calculation is performed for predicting the power generation set value Sc(k) in the future, the power storage set value Sb(k) in the future, and the charged power amount Cb(k) in the future.

[B-8-4] Step ST414

Next, in step ST414, it is determined whether the maximum value of the future value Cb(k) of the charged power amount Cb (residual amount) of the power storage unit 20 is larger than the upper limit value Cbmax of the power amount to be stored in the power storage unit 20 (ST414).

[B-8-5] Step ST415

When it is determined as YES in step ST414 (maximum value of Cb(k)>Cbmax), the time point Tc is updated in step ST415 (ST415). Here, a value as a result of adding the predetermined value q1 to the present time point Tc, is set to the updated time point Tc. The updated time point Tc is used in step ST413.

[B-8-6] Step ST416

When it is determined as No in step ST414 (maximum value of Cb(k)≤Cbmax), it is determined, in step ST416, whether the minimum value of the future value Cb(k) of the charged power amount Cb (residual amount) of the power storage unit 20 is smaller than the lower limit value Cbmin of the power amount to be stored in the power storage unit 20.

[B-8-7] Step ST417

When it is determined as Yes in step ST416 (minimum value of Cb(k)<Cbmin), the output change rate Rb is updated in step ST417. Here, a value as a result of adding the predetermined value q2 to the present output change rate Rb, is set to the updated output change rate Rb. The updated output change rate Rb is used in step ST413.

[B-8-8] Step ST418

When it is determined as No in step ST416 (minimum value of Cb(k)≥Cbmin), the total set value St(1) in the next step of the present time point and the corrected increase-side output change rate Rbpa are decided in step ST418. Here, as expressed by a following (equation 2-1), the already-set output change rate Rb is set to the corrected increase-side output change rate Rbpa. Further, the total set value St(1) in the next step of the present time point is decided based on a following (equation 3-1).

Rbpa=Rb (Equation 2-1)

St(1)=St(0)+(Rbpa+Rcp)*dt (Equation 3-2)

[B-9] Processing when Request Value is Decreased

The processing when the request value is decreased (refer to ST42 in FIG. 13A) will be described by using FIG. 13C.

[B-9-1] Step ST421

When performing the processing when the request value is decreased, as illustrated in FIG. 13C, an initial value of the output change rate Rb of the power storage unit 20 is first set in step ST421. Here, the output change rate Rb of the power storage unit 20 is set to the minimum value Rbmmin (Rb=Rbmmin).

[B-9-2] Step ST422

Next, in step ST422, an initial value of the time point Tc when the power generation set values Sc(1), Sc(2), . . . , Sc(N) at respective time points start to change is set. Here, the present time point (0) is set as the time point Tc (Tc=0).

[B-9-3] Step ST423

Next, in step ST423, calculation is performed for predicting the power generation set value Sc(k) in the future, the power storage set value Sb(k) in the future, and the charged power amount Cb(k) in the future.

[B-9-4] Step ST424

Next, in step ST424, it is determined whether the minimum value of the future value Cb(k) of the charged power amount Cb (residual amount) of the power storage unit 20 is smaller than the lower limit value Cbmin of the power amount to be stored in the power storage unit 20.

[B-9-5] Step ST425

When it is determined as Yes in step ST424 (minimum value of Cb(k)<Cbmin), the time point Tc is updated (ST425). Here, a value as a result of adding the predetermined value q3 to the present time point Tc, is set to the updated time point Tc. The updated time point Tc is used in step ST423.

[B-9-6] Step ST426

When it is determined as No in step ST424 (minimum value of Cb(k)≥Cbmin), it is determined, in step ST426, whether the maximum value of the future value Cb(k) of the charged power amount Cb (residual amount) of the power storage unit 20 is larger than the upper limit value Cbmax of the power amount to be stored in the power storage unit 20.

[B-9-7] Step ST427

When it is determined as Yes in step ST426 (maximum value of Cb(k)>Cbmax), the output change rate Rb is updated in step ST427. Here, a value as a result of adding the predetermined value q4 to the present output change rate Rb, is set to the updated output change rate Rb. The updated output change rate Rb is used in step ST423.

[B-9-8] Step ST428

When it is determined as No in step ST426 (maximum value of Cb(k)≤Cbmax), the total set value St(1) in the next step of the present time point and the corrected decrease-side output change rate Rbma are decided in step ST428. Here, as expressed by a following (equation 2-2), the already-set output change rate Rb is set to the corrected increase-side output change rate Rbpa. Further, the total set value St(1) in the next step of the present time point is decided based on a following (equation 3-2).

Rbma=Rb (Equation 2-2)

St(1)=St(0)+(Rbma+Rcm)*dt (Equation 3-2)

[C] Regarding Total Set Value St, Power Generation Set Value Sc, Power Storage Set Value Sb, and Charged Power Amount Cb

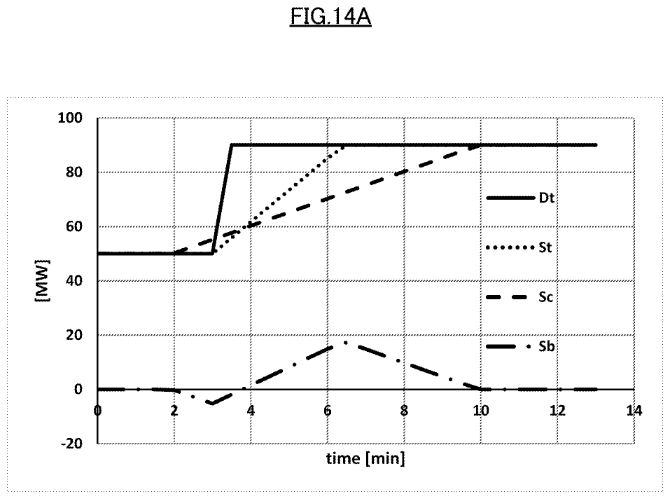

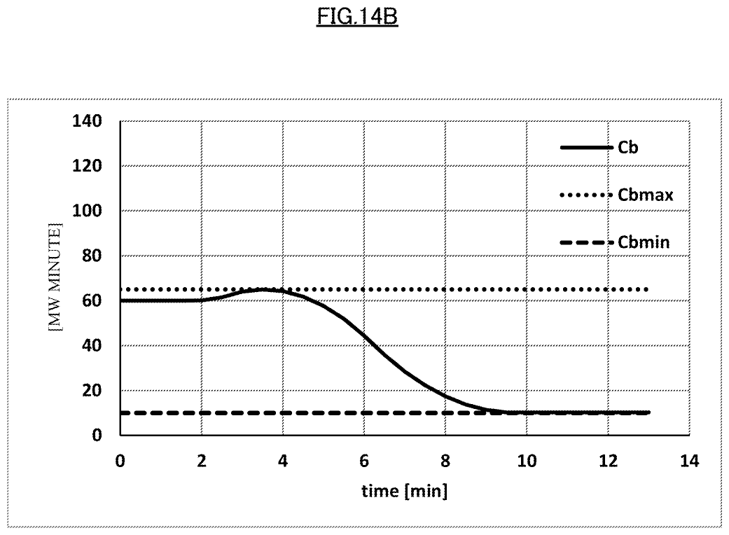

The total set value St, the power generation set value Sc, and the power storage set value Sb calculated in the cooperation control unit 500, will be described by using FIG. 14A. Further, the charged power amount Cb charged in the power storage unit 20 when calculating the total set value St, the power generation set value Sc, and the power storage set value Sb as described above, will be described by using FIG. 14B.

Each of FIG. 14A and FIG. 14B illustrates, as an example, a state in which rising of the power demand amount Dt at a 3-minute time point is already known at a 0-minute time point (present time point), unlike the case illustrated in FIG. 11A and FIG. 11B.

As illustrated in FIG. 14A, the total set value St is set to start rising from the 3-minute time point, and to rise from 50 MW to 90 MW by about a 6.5-minute time point, according to the timing of rising of the power demand amount Dt. Further, the total set value St keeps a fixed value at about the 6.5-minute time point and thereafter, for example, similarly to the power demand amount Dt of the power system 40.

However, in the present embodiment, the rising of the power demand amount Dt at the 3-minute time point is already known at the 0-minute time point (present time point), similarly to the third embodiment. For this reason, in the present embodiment, the power generation set value Sc is set to rise before the rising of the power demand amount Dt, as illustrated in FIG. 14A. Concretely, the power generation set value Sc is set to make a power amount rise from 50 MW to 90 MW during a period from a 2-minute time point to a 10-minute time point by passing through the time point (3-minute time point) at which the power demand amount Dt rises, for example. Further, the power generation set value Sc keeps a fixed value at the 10-minute time point and thereafter, for example, similarly to the power demand amount Dt of the power system 40.

The power generated by the power generation unit 10 so as to correspond to the power generation set value Sc before the rising of the power demand amount Dt, is not required to be output to the power system 40, so that the power is charged in the power storage unit 20. For this reason, the power storage set value Sb indicates that the charge is performed during a period from a 2-minute time point to about a 4-minute time point, and the discharge is performed at about the 4-minute time point and thereafter.

At this time, the charged power amount Cb charged in the power storage unit 20 increases when performing the charge, and it decreases when performing the discharge, as illustrated in FIG. 11B. For instance, the charge is performed from the state where the charged power amount Cb is 60 MW at the 0-minute time point to 65 MW being the upper limit value Cbmax of the charged power amount Cb, and the discharge is performed from that state to 10 MW being the lower limit value Cbmin of the charged power amount Cb.

Summary

As described above, in the power control apparatus 50 of the present embodiment, the cooperation control unit 500 outputs the power generation set value Sc and the power storage set value Sb so that the charged power amount Cb to be charged in the power storage unit 20 falls within the previously set range (the range between the upper limit value Cbmax and the lower limit value Cbmin). For this reason, in the present embodiment, it is possible to arbitrarily set the capacity of the power storage unit 20. Therefore, in the present embodiment, it is possible to easily realize efficient power supply.

### Fifth Embodiment

[A] Cooperation Control Unit 500

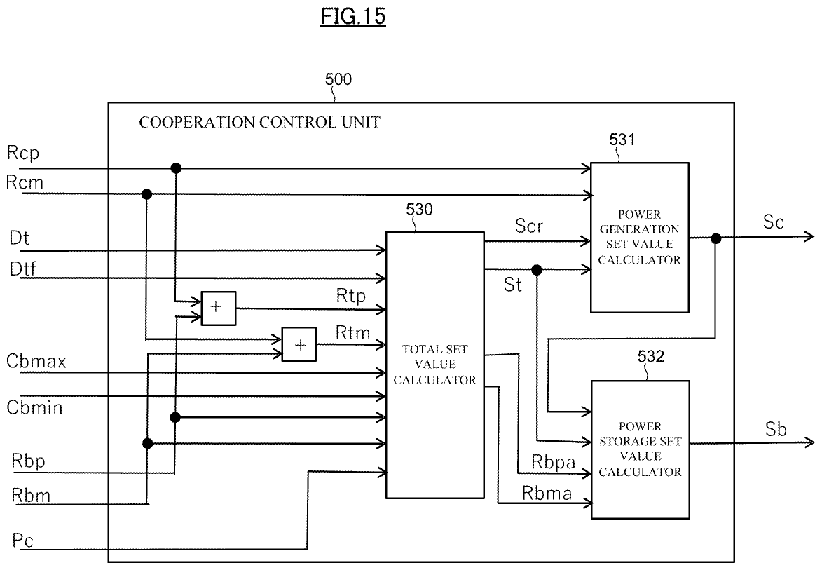

A substantial part of a cooperation control unit 500 of the present embodiment will be described by using FIG. 15.

Unlike the fourth embodiment (refer to FIG. 12), data of power Pc output by the power generation unit 10 (power generation output value) is input to the cooperation control unit 500 of the present embodiment, as illustrated in FIG. 15. Except for this point and points related thereto, the present embodiment is similar to the above-described embodiments. For this reason, explanation of overlapped parts will be appropriately omitted.

Concretely, in the cooperation control unit 500, the data of power Pc output by the power generation unit 10 is input, as an input signal, to the total set value calculator 530. Subsequently, the total set value calculator 530 further uses actual measured data of the power Pc output by the power generation unit 10, and so on, to calculate the total set value St, and it also calculates a corrected power generation set value Scr.

[A-1] Total Set Value Calculator 530

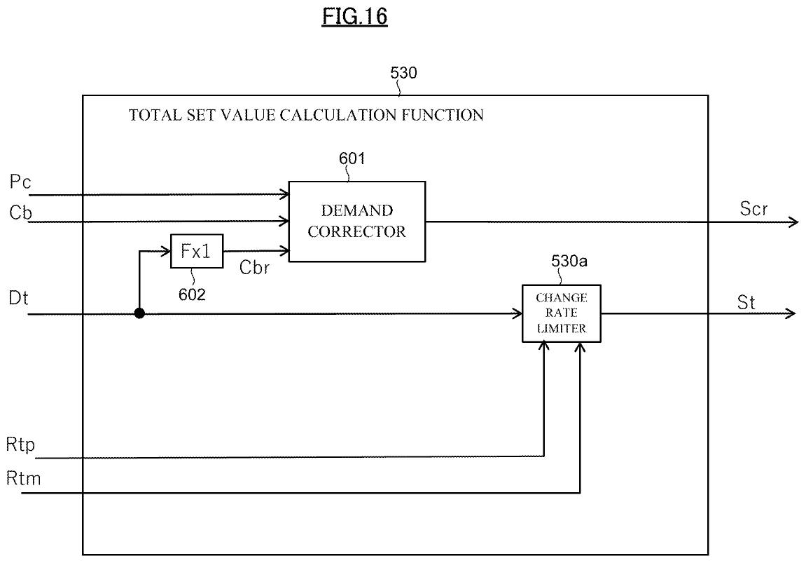

A substantial part of the total set value calculator 530 of the present embodiment will be described by using FIG. 16.

As illustrated in FIG. 16, the total set value calculator 530 further includes a demand corrector 601 and a function unit 602, in addition to the change rate limiter 530a.

To the demand corrector 601, respective pieces of data regarding the power Pc output by the power generation unit 10, the charged power amount Cb charged in the power storage unit 20, and a target value Cbr of the charged power amount Cb determined in the function unit 602, are input as input signals. Subsequently, the demand corrector 601 calculates and outputs the corrected value Scr of the power generation set value Sc, based on the respective input signals.

The function unit 602 is configured such that the power demand amount Dt of the power system 40 is input thereto as an input signal, and it outputs the target value Cbr of the charged power amount Cb as an output signal.

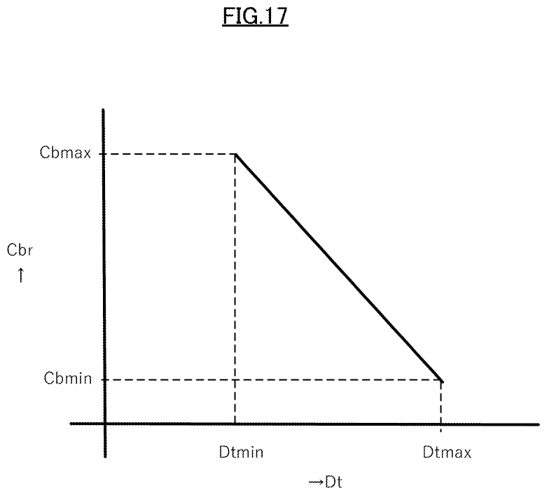

An example of a function of the function unit 602 will be described by using FIG. 17.

As illustrated in FIG. 17, the function unit 602 is configured to reduce the target value Cbr of the charged power amount Cb in accordance with the increase in the power demand amount Dt of the power system 40.

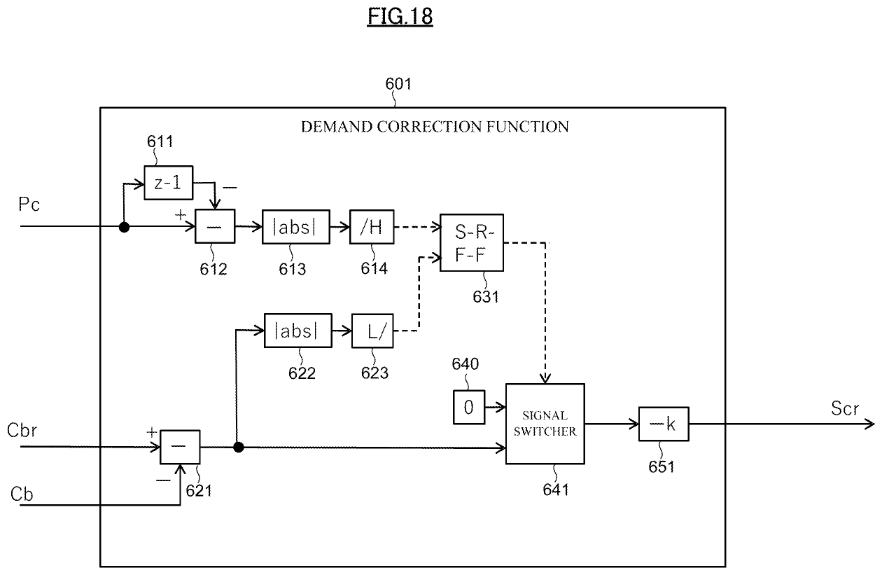

A substantial part of the demand corrector 601 will be described by using FIG. 18. In FIG. 18, a solid line indicates an analog signal, and a dotted line indicates a logical signal.

As illustrated in FIG. 18, the demand corrector 601 includes a shift register 611, a subtractor 612, an absolute value calculator 613, a high value detector 614, a subtractor 621, an absolute value calculator 622, a low value detector 623, a set-reset flip-flop 631, a zero signal generator 640, a signal switcher 641, and a gain 651.

To the shift register 611, the data of power Pc output by the power generation unit 10 is input for each step. Subsequently, the shift register 611 outputs the data of power Pc held in the last step.

To the subtractor 612, the data of power Pc output by the power generation unit 10 is input, and the data of power Pc in the last step output from the shift register 611 is input. Subsequently, the subtractor 612 calculates and outputs a difference value between the both pieces of input data.

The absolute value calculator 613 is configured to determine and output an absolute value of the difference value output from the subtractor 612.

When the absolute value output from the absolute value calculator 613 is larger than a previously set threshold value, the high value detector 614 outputs a logical value of True, and when the absolute value is smaller than the threshold value, the high value detector 614 outputs a logical value of False.

To the subtractor 621, the charged power amount Cb charged in the power storage unit 20, and the target value Cbr of the charged power amount Cb determined by the function unit 602 (refer to FIG. 16) are input as input signals. Subsequently, the subtractor 621 calculates and outputs a difference value between the both pieces of input data.

The absolute value calculator 622 is configured to determine and output an absolute value of the difference value output from the subtractor 621.

When the absolute value output from the absolute value calculator 613 is larger than a previously set threshold value, the low value detector 623 outputs a logical value of False, and when the absolute value is smaller than the threshold value, the low value detector 623 outputs a logical value of True.

To the set-reset flip-flop 631, the logical value is input from the high value detector 614, and the logical value is input from the low value detector 623. Further, when the logical value input from the low value detector 623 is True, the set-reset flip-flop 631 outputs False even if the logical value input from the high value detector 614 is any value. Further, when the logical value input from the low value detector 623 is False, the set-reset flip-flop 631 outputs True when the logical value input from the high value detector 614 is True. At this time, the set-reset flip-flop 631 keeps outputting True until when the logical value input from the low value detector 623 changes from False to True. Further, when the logical value input from the low value detector 623 is False, the set-reset flip-flop 631 outputs False when the logical value input from the high value detector 614 is False.

The zero signal generator 640 outputs a signal whose value is zero.

To the signal switcher 641, the difference value output from the subtractor 621 is input, and the logical value is input from the set-reset flip-flop 631. Subsequently, when the logical value input from the set-reset flip-flop 631 is True, the signal switcher 641 outputs the zero value input from the zero signal generator 640. On the other hand, when the logical value input from the set-reset flip-flop 631 is False, the signal switcher 641 outputs the difference value input from the subtractor 621.

Specifically, when the difference value output from the subtractor 621 is small, or when the change in the power Pc output by the power generation unit 10 is large, the signal switcher 641 outputs the zero value. On the other hand, when the difference value output from the subtractor 621 is large and the change in the power Pc output by the power generation unit 10 is small, the signal switcher 641 outputs the difference value output from the subtractor 621.

The gain processor 651 performs gain processing on the signal input from the signal switcher 641, and outputs the processed signal (a gain k has a positive value).

[A-2] Power Generation Set Value Calculator 531

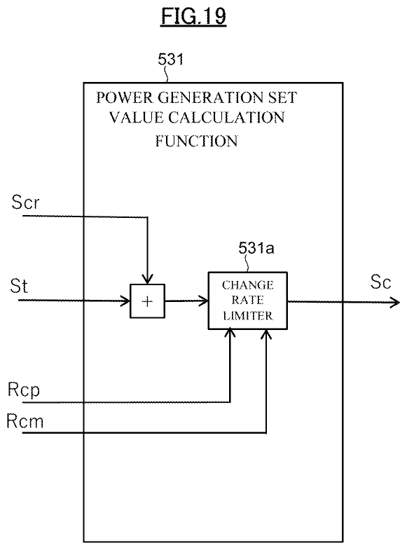

The power generation set value calculator 531 will be described by using FIG. 19.

As illustrated in FIG. 19, in the power generation set value calculator 531, an added value of the total set value St and the corrected power generation set value Scr is input to the change rate limiter 531a, and the increase-side output change rate Rcp and the decrease-side output change rate Rcm are input to the change rate limiter 531a. Subsequently, the change rate limiter 531a calculates and outputs the power generation set value Sc being the set value of power to be output by the power generation unit 10, based on the respective input signals.

[B] Regarding Target Value Cbr of Charged Power Amount Cb, Total Set Value St, Power Generation Set Value Sc, Power Storage Set Value Sb, and Charged Power Amount Cb

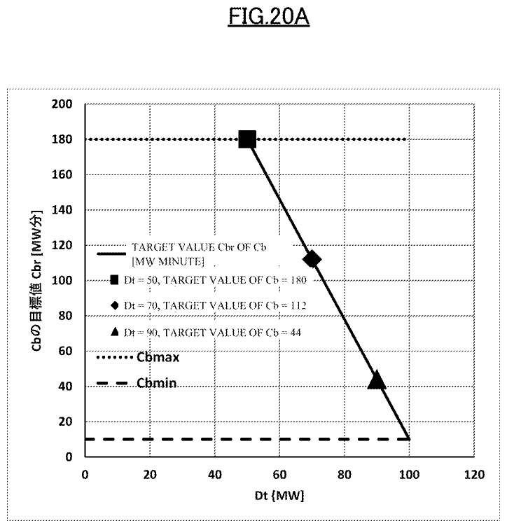

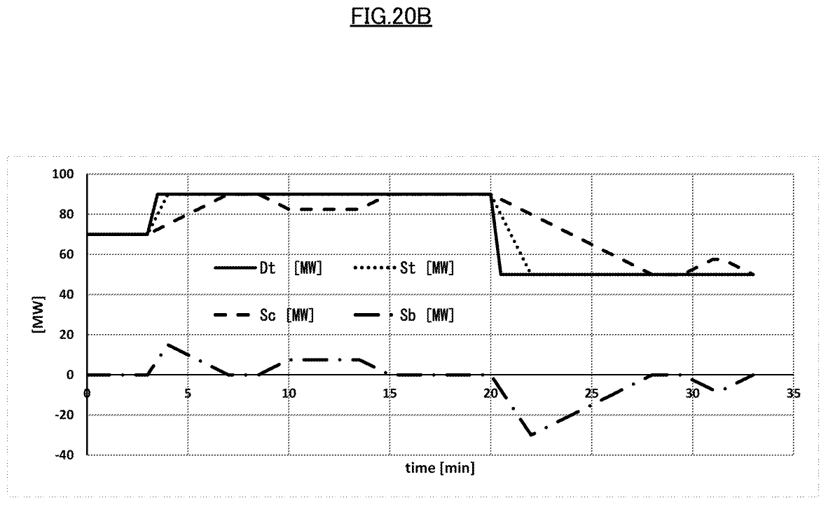

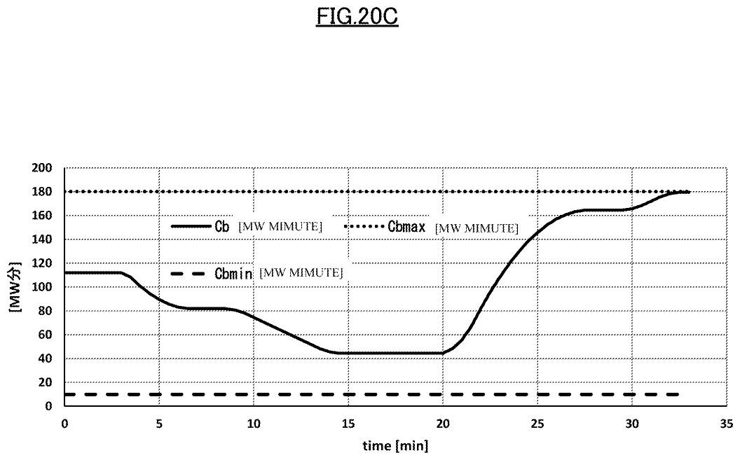

First, an example of a function of the function unit 602 in the present embodiment will be described by using FIG. 20A.

As illustrated in FIG. 20A, the function of the function unit 602 is configured such that the target value Cbr of the charged power amount Cb is reduced in accordance with the increase in the power demand amount Dt of the power system 40. For example, when the power demand amount Dt is 50 MW, the target value Cbr is 180 MW. For example, when the power demand amount Dt is 70 MW, the target value Cbr is 112 MW. For example, when the power demand amount Dt is 90 MW, the target value Cbr is 44 MW.

Next, the total set value St, the power generation set value Sc, and the power storage set value Sb will be described by using FIG. 20B, and the charged power amount Cb will be described by using FIG. 20C.

Each of FIG. 20B and FIG. 20C illustrates, as an example, a case where the power demand amount Dt rises from 70 MW to 90 MW, and then it decreases from 90 MW to 50 MW.

In this case, at a 0-minute time point, the charged power amount Cb is 112 MW, as can be confirmed from FIG. 20A. Since the charged power amount Cb is sufficiently large, when the power demand amount Dt rises from 70 MW to 90 MW, the power generation set value Sc changes smoothly. Here, the power generation set value Sc reaches 90 MW at a 7-minute time point, and at a time point slightly delayed from the 7-minute time point, the power Pc output by the power generation unit 10 reaches 90 MW. The value of the power Pc output by the power generation unit 10 is substantially the same as the power generation set value Sc, so that illustration thereof is omitted.

At the 7-minute time point, the charged power amount Cb is 82 MW, which is larger than 44 MW being the target value Cbr when the power demand amount Dt is 90 MW. In a state where the power Pc output by the power generation unit 10 keeps a fixed value of 90 MW, the corrected power generation set value Scr (illustration thereof is omitted) changes so as to approximate the charged power amount Cb to the target value Cbr, so that the power generation set value Sc changes. Here, the power demand amount Dt and the total set value St coincide with each other.

At a 15-minute time point, the charged power amount Cb coincides with the target value Cbr, so that the corrected power generation set value Scr (illustration thereof is omitted) becomes zero.

Further, at a 20-minute time point and thereafter, the power demand amount Dt decreases from 90 MW to 50 MW. At this time, the charged power amount Cb of power charged in the power storage unit 20 is small. Accordingly, in the power storage unit 20, it is possible to sufficiently charge the power Pc output by the power generation unit 10. As a result of this, in the present embodiment, the total set value St smoothly follows the power demand amount Dt.

[C] Summary

As described above, the cooperation control unit 500 of the present embodiment sets the charged power set value Cbr based on the power demand amount Dt. Further, the cooperation control unit 500 outputs the power generation set value Sc and the power storage set value Sb so that the charged power amount Cb becomes the charged power set value Cbr at the power demand amount Dt. Therefore, in the present embodiment, when the power storage unit 20 is required to charge the power Pc output by the power generation unit 10 as described above, the capacity capable of being charged by the power storage unit 20 can be secured, and thus it is possible to accurately deal with the requested power demand amount Dt.

### Sixth Embodiment

Although illustration is omitted, in the present embodiment, the power generation unit 10 (refer to FIG. 1) is a combined cycle power generation system, and is configured to generate power by using a gas turbine, and generate power by using a steam turbine as well. Further, the power generation control unit 510 is configured to control an output of the gas turbine and an output of the steam turbine.

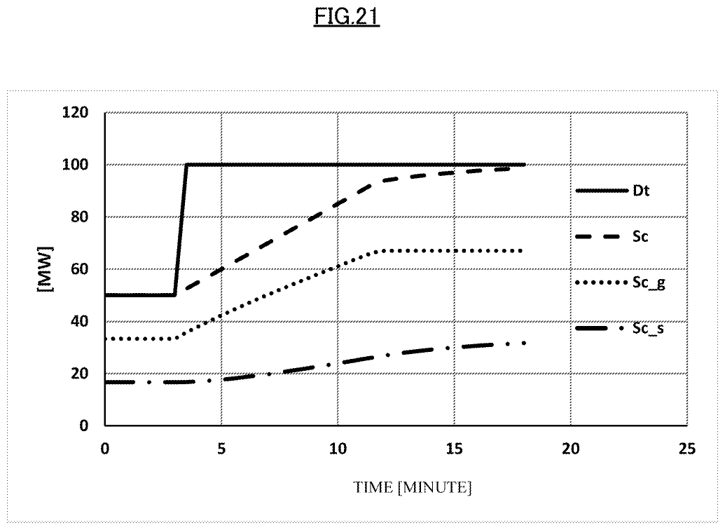

A power generation set value Sc of the present embodiment will be described by using FIG. 21. In FIG. 21, both an output set value Sc_g of the gas turbine and an output set value Sc_s of the steam turbine are illustrated, and the sum of the output set value Sc_g of the gas turbine and the output set value Sc_s of the steam turbine corresponds to the power generation set value Sc.

The output set value Sc_g of the gas turbine is set to increase the output at 5% MW/minute, for example. On the other hand, the output set value Sc_s of the steam turbine is set to increase the output by being delayed relative to the output set value Sc_g of the gas turbine, so as to correspond to characteristics of the steam turbine.

As described above, when the power generation unit 10 is the combined cycle power generation system which generates power by using the gas turbine and generates power by using the steam turbine as well, it is possible to perform the output control similarly to the above-described respective embodiments, by considering the output characteristics as described above.

<Others>

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### EXPLANATION OF REFERENCE NUMERALS

10: power generation unit, 20: power storage unit, 40: power system, 50: power control apparatus, 500: cooperation control unit, 510: power generation control unit, 520: power storage control unit, 530: total set value calculator, 530a: change rate limiter, 531: power generation set value calculator, 531a: change rate limiter, 532: power storage set value calculator, 532a: change rate limiter, 601: demand corrector, 602: function unit, 611: shift register, 612: subtractor, 613: absolute value calculator, 614: high value detector, 621: subtractor, 622: absolute value calculator, 623: low value detector, 631: set-reset flip-flop, 640: zero signal generator, 641: signal switcher, 651: gain processor

1. A power control apparatus for controlling power to be output to a power system from a power station including a power generation unit configured to generate power, and a power storage unit configured to charge or discharge power, the power control apparatus comprising:
a power generation control unit for controlling an output of the power generation unit based on a power generation set value;
a power storage control unit for controlling an output of the power storage unit based on a power storage set value; and
a cooperation control unit for outputting the power generation set value to the power generation control unit and outputting the power storage set value to the power storage control unit based on a power demand amount of the power system so as to make the power generation unit and the power storage unit operate in a cooperative manner.

2. The power control apparatus according to claim 1, wherein
the cooperation control unit outputs the power generation set value and the power storage set value based further on an increase-side output change rate and a decrease-side output change rate of the power generation unit, and an increase-side output change rate and a decrease-side output change rate of the power storage unit.

3. The power control apparatus according to claim 1, wherein
the cooperation control unit outputs the power generation set value and the power storage set value based further on a charged power amount charged in the power storage unit.

4. The power control apparatus according to claim 1, wherein
the cooperation control unit outputs the power generation set value and the power storage set value based on a power demand amount in the future, in addition to a power demand amount at a present time point of the power system.

5. The power control apparatus according to claim 1, wherein
the cooperation control unit outputs the power generation set value and the power storage set value so as to make the charged power amount to be charged in the power storage unit fall within a previously set range.

6. The power control apparatus according to claim 5, wherein
the cooperation control unit sets a charged power set value based on the power demand amount, and outputs the power generation set value and the power storage set value so that the charged power amount becomes the charged power set value at the power demand amount.

7. The power control apparatus according to claim 1, wherein:
the power generation unit is configured to generate power by using a gas turbine, and generate power by using a steam turbine as well; and
the power generation control unit is configured to control an output of the gas turbine and an output of the steam turbine.

8. A power control method which controls power to be output to a power system from a power station including a power generation unit configured to generate power, and a power storage unit configured to charge or discharge power, the power control method comprising
controlling an output of the power generation unit and an output of the power storage unit based on a power demand amount of the power system so as to make the power generation unit and the power storage unit operate in a cooperative manner.
